(19) United States
(12) Patent Application Publication
(10) Pub. No.: US 2020/0008461 A1
(43) Pub. Date: Jan. 9, 2020

(54) BEVERAGE BOTTLE DRESSING ASSEMBLY

(71) Applicant: Gerald Anderson, Houston, TX (US)

(72) Inventor: Gerald Anderson, Houston, TX (US)

(21) Appl. No.: 16/026,944

(22) Filed: Jul. 3, 2018

(51) Int. Cl. A23P 10/10; A23L 2/56; B05C 3/20; B05C 19/00; B65D 85/72

(52) U.S. Cl. CPC A23P 10/10; A23L 2/56; B65D 81/32; B05C 19/001; B65D 85/72; B05C 3/20

(57) ABSTRACT

A beverage bottle dressing assembly for dressing a beverage bottle with granular flavoring includes a beverage bottle that has a neck and an opening extending into the neck for drinking. A cylinder is included that has a pair of chambers therein and the chambers are fluidly discrete from each other. Each of the chambers contains a respective one of a fluid and a granular flavoring. The cylinder has a pair of openings each extending into a respective one of the chambers and each of the openings insertably receiving the neck of the beverage bottle for depositing the fluid and granular flavoring on the neck. In this way the fluid and granular flavorings enhance consuming a beverage contained in the beverage bottle.

### (b) CROSS-REFERENCE TO RELATED APPLICATIONS

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to dressing devices and more particularly pertains to a new dressing device for dressing a beverage bottle with granular flavoring.

### (h) BRIEF SUMMARY OF THE INVENTION

An embodiment of the disclosure meets the needs presented above by generally comprising a beverage bottle that has a neck and an opening extending into the neck for drinking. A cylinder is included that has a pair of chambers therein and the chambers are fluidly discrete from each other. Each of the chambers contains a respective one of a fluid and a granular flavoring. The cylinder has a pair of openings each extending into a respective one of the chambers and each of the openings insertably receiving the neck of the beverage bottle for depositing the fluid and granular flavoring on the neck. In this way the fluid and granular flavorings enhance consuming a beverage contained in the beverage bottle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a beverage bottle dressing assembly according to an embodiment of the disclosure.

FIG. 2 is a right side view of an embodiment of the disclosure.

FIG. 3 is a top view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### (j) DETAILED DESCRIPTION OF THE INVENTION

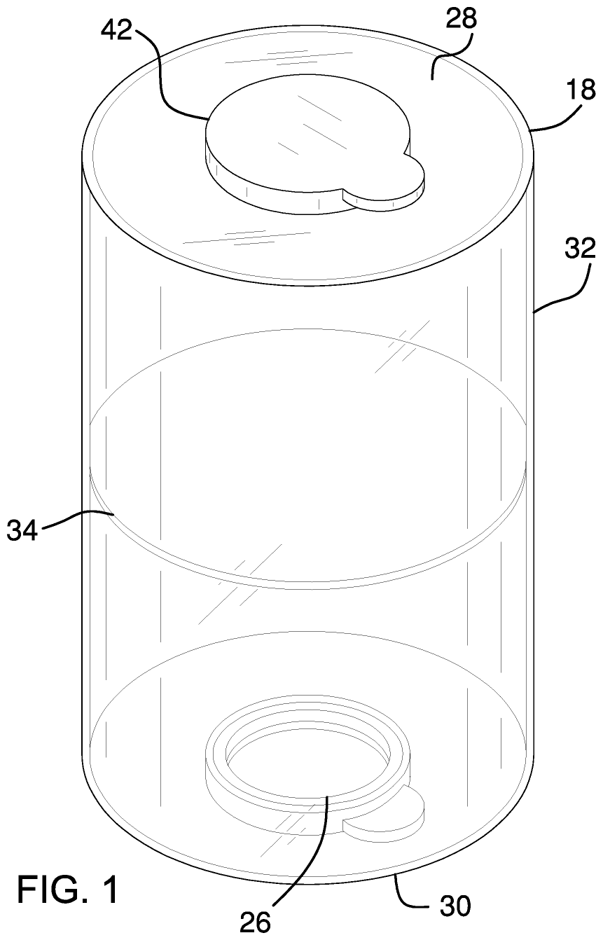

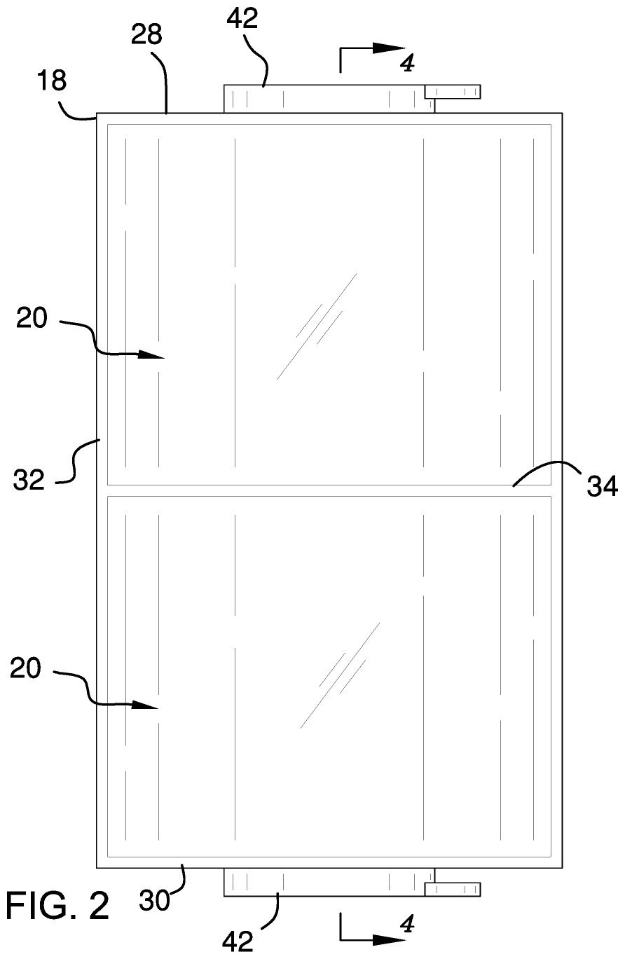

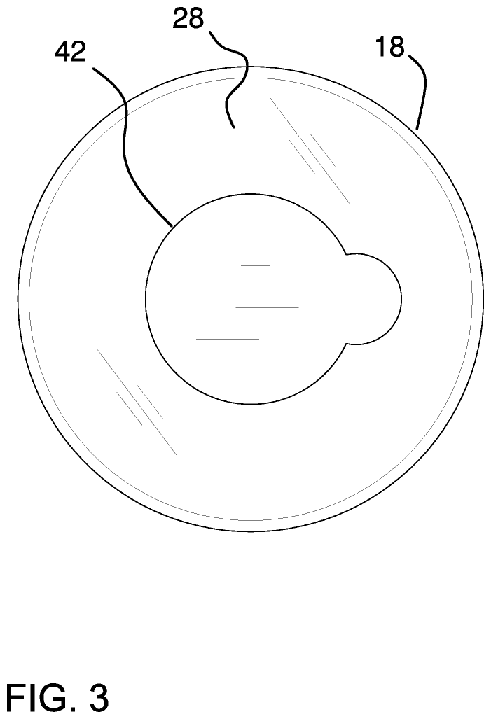

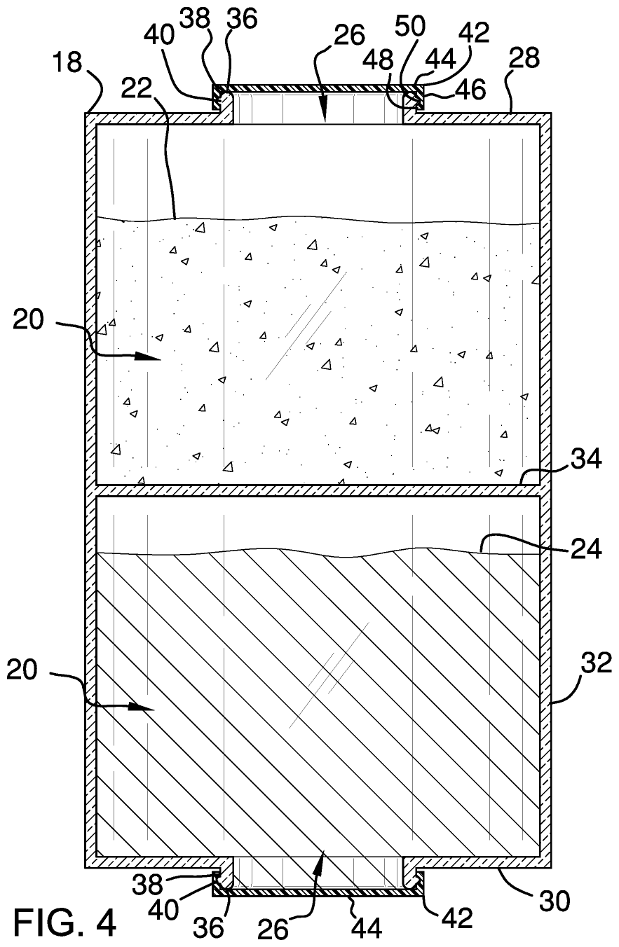

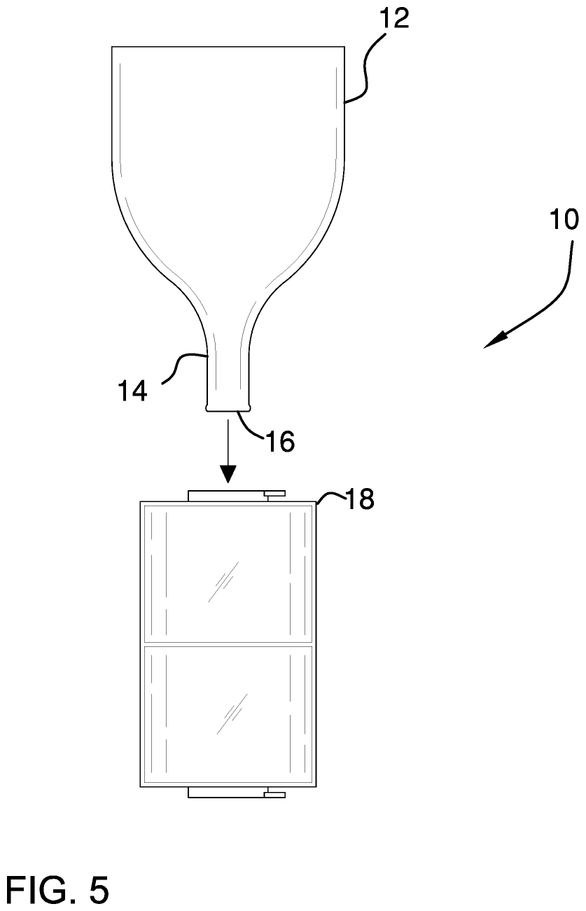

With reference now to the drawings, and in particular to FIGS. 1 through 5 thereof, a new dressing device embodying the principles and concepts of an embodiment of the disclosure and generally designated by the reference numeral 10 will be described.

As best illustrated in FIGS. 1 through 5, the beverage bottle dressing assembly 10 generally comprises a beverage bottle 12 that has a neck 14 and an opening 16 extending into the neck 14 for drinking. A cylinder 18 is provided that has a pair of chambers 20 therein and the chambers 20 are fluidly discrete from each other. Each of the chambers 20 contains a respective one of a fluid 22 and a granular flavoring 24. The fluid 22 may be fruit juice or other sugary fluid 22 that has adhesive properties beyond that of pure water. The granular flavoring 24 may be salt or other granular flavoring 24 that can adhere to the fluid 22.

The cylinder 18 has a pair of openings 26 each extending into a respective one of the chambers 20. Each of the openings 26 insertably receives the neck 14 of the beverage bottle 12 for depositing the fluid 22 and granular flavoring 24 on the neck 14. In this way the fluid 22 and granular flavoring 24 enhance consuming a beverage contained in the beverage bottle 12 with respect to the additional flavors imparted onto the beverage bottle 12.

The cylinder 18 has a first end 28, a second end 30 and an outer wall 32 extending therebetween, and a dividing wall 34 is positioned in the cylinder 18 to define each of the chambers 20. The dividing wall 34 is positioned between the first end 28 and the second end 30. Each of the first end 28 and the second end 30 has a respective one of the openings 26 extending therethrough and the cylinder 18 is comprised of a translucent material.

A pair of lips 36 is each coupled to a respective one of the first 28 and second 30 ends of the cylinder 18. Each of the lips 36 is aligned with the opening 16 in the respective first 28 and second 30 end and each of the lips 36 is continuous such that each of the lips 36 surrounds the opening 16 in the respective first 28 and second 30 end. Each of the lips 36 has an outwardly facing surface 38 and the outwardly facing surface 38 of each of the lips 36 has a ridge 40 extending outwardly therefrom. The ridge 40 on each of the lips 36 extends around an entire circumference of the lips 36.

A pair of lids 42 is provided and each of the lids 42 is removably coupled to the cylinder 18. Each of the lids 42 is aligned with a respective one of the openings 26 for closing the respective opening 16. Each of the lids 42 has a top wall 44 and a perimeter wall 46 extending downwardly therefrom, and the perimeter wall 46 of each of the lids 42 has an inwardly facing surface 48. The inwardly facing surface 48 of the perimeter wall 46 of each of the lids 42 has a groove 50 extending therein. Moreover, the groove 50 associated with each of the lids 42 frictionally engages the ridge 40 of a respective one of the lips 36 for retaining the lids 42 on the respective lips 36.

In use, the fluid 22 is poured into a one of the chambers 20 in the cylinder 18 and the granular flavoring 24 is poured into the other chamber 20 in the cylinder 18. Each of the lids 42 is coupled to the cylinder 18 to close each of the chambers 20 for retaining the fluid 22 and the granular flavoring 24 in the cylinder 18. The lid 42 positioned over the chamber 20 containing the fluid 22 is removed and the neck 14 of the beverage bottle 12 is extended through the opening 26 in the chamber 20 containing the fluid 22. Thus, the fluid 22 is deposited around the neck 14 of the beverage bottle 12. The lid 42 for closing the chamber with the fluid 22 is replaced, the cylinder 18 is inverted and the lid 42 positioned over the chamber 20 containing the granular flavoring 24 is removed. The neck 14 of the beverage bottle 12 is extended through the opening 26 in the chamber containing the granular flavoring 24. Thus, the granular flavoring 24 sticks to the fluid 22 that has been deposited on the neck 14 of the beverage bottle 12. In this way the granular flavoring 24 is deposited on the neck 14 of the beverage bottle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A beverage bottle dressing assembly, said assembly comprising:
a beverage bottle having a neck and an opening extending into said neck for drinking;
a cylinder having a pair of chambers therein, said chambers being fluidly discrete from each other, each of said chambers containing a respective one of a fluid and a granular flavoring, said cylinder having a pair of openings each extending into a respective one of said chambers, each of said openings having a circumference such that the neck of the beverage bottle is selectively insertable into each chamber for depositing the fluid and granular flavoring on the neck wherein said fluid and granular flavorings are configured to enhance consuming a beverage contained in said beverage bottle; and
a pair of lids, each of said lids being removably coupled to said cylinder, each of said lids being aligned with a respective one of said openings for closing said respective opening.

2. The assembly according to claim 1, wherein said cylinder has a first end, a second end and an outer wall extending therebetween, said cylinder having a dividing wall being positioned therein to define each of said chambers, said dividing wall being positioned between said first end and said second end, each of said first end and said second end having a respective one of said openings extending therethrough, said cylinder being comprised of a translucent material.

3. The assembly according to claim 2, further comprising a pair of lips, each of said lips being coupled to a respective one of said first and second ends of said cylinder, each of said lips being aligned with said opening in said respective first and second end, each of said lips being continuous such that each of said lips surrounds said opening in said respective first and second end.

4. The assembly according to claim 3, wherein each of said lips has an outwardly facing surface, said outwardly facing surface of each of said lips having a ridge extending outwardly therefrom, said ridge on each of said lips extending around an entire circumference of said lips.

5. The assembly according to claim 1, further comprising:
said cylinder having a first end, a second end and an outer wall extending therebetween, each of said first end and said second end having a respective one of said openings extending therethrough;
a pair of lips, each of said lips being coupled to a respective one of said first and second ends of said cylinder, each of said lips being aligned with said opening in said respective first and second end, each of said lips being continuous such that each of said lips surrounds said opening in said respective first and second end, each of said lips having an outwardly facing surface, said outwardly facing surface of each of said lips having a ridge extending outwardly therefrom, said ridge on each of said lips extending around an entire circumference of said lips; and
each of said lids having a top wall and a perimeter wall extending downwardly therefrom, said perimeter wall of each of said lids having an inwardly facing surface, said inwardly facing surface of said perimeter wall of each of said lids having a groove extending therein, said groove associated with each of said lids frictionally engaging said ridge of a respective one of said lips for retaining said lids on said respective lips.

6. A beverage bottle dressing assembly, said assembly comprising:
a beverage bottle having a neck and an opening extending into said neck for drinking;
a cylinder having a pair of chambers therein, said chambers being fluidly discrete from each other, each of said chambers containing a respective one of a fluid and a granular flavoring, said cylinder having a pair of openings each extending into a respective one of said chambers, each of said openings having a circumference such that the neck of the beverage bottle is selectively insertable into each chamber for depositing the fluid and granular flavoring on the neck wherein said fluid and granular flavorings are configured to enhance consuming a beverage contained in said beverage bottle, said cylinder having a first end, a second end and an outer wall extending therebetween, said cylinder having a dividing wall being positioned therein to define each of said chambers, said dividing wall being positioned between said first end and said second end, each of said first end and said second end having a respective one of said openings extending therethrough, said cylinder being comprised of a translucent material;
a pair of lips, each of said lips being coupled to a respective one of said first and second ends of said cylinder, each of said lips being aligned with said opening in said respective first and second end, each of said lips being continuous such that each of said lips surrounds said opening in said respective first and second end, each of said lips having an outwardly facing surface, said outwardly facing surface of each of said lips having a ridge extending outwardly therefrom, said ridge on each of said lips extending around an entire circumference of said lips; and
a pair of lids, each of said lids being removably coupled to said cylinder, each of said lids being aligned with a respective one of said openings for closing said respective opening, each of said lids having a top wall and a perimeter wall extending downwardly therefrom, said perimeter wall of each of said lids having an inwardly facing surface, said inwardly facing surface of said perimeter wall of each of said lids having a groove extending therein, said groove associated with each of said lids frictionally engaging said ridge of a respective one of said lips for retaining said lids on said respective lips.
